(19) United States
(12) Patent Application Publication
(10) Pub. No.: US 2003/0208766 A1
(43) Pub. Date: Nov. 6, 2003

(54) System for reproducing and delivering digital content

(76) Inventor: Nobuyuki Tanaka, Tokyo (JP)

Correspondence Address: McGinn & Gibb, PLLC, Suite 200, 8321 Old Courthouse Road, Vienna, VA, 22182-3817, US

(21) Appl. No.: 09/824,035

(22) Filed: Apr. 3, 2001

(30) Foreign Application Priority Data
Apr. 4, 2000 (JP) 102135/2000

(51) Int. Cl. H04N 7/173

(52) U.S. Cl. 725/91

(57) ABSTRACT

In a digital content reproducing system, a projecting system receives a digital content of a movie from a content server via a LAN and the digital content are stored in a mass memory unit. Thereafter, when the digital content are reproduced, the digital content are read out from the mass memory unit, decrypted by a decrypt module, and separated into video data and audio data by an AV separating module. Finally, the video data and the audio data are decoded by the corresponding decoder, and the video data are projected on a screen and the audio data are output to a loudspeaker.

### BACKGROUND OF THE INVENTION

1. Field of the Invention

The invention relates to a digital content reproducing system which reproduces a digital content such as a movie and also to a digital content delivery system which sends and receives the digital content via a network.

1. Description of the Related Art

In a conventional reproducing system used in a movie theater, movie images recorded or shot on a film are generally projected or shown on a screen. Also, a movie sound is reproduced through a loudspeaker by outputting audio data stored in, for example, a CD-ROM.

Therefore, to show a movie in several theaters, the film recording the movie images should be copied by a film studio and delivered to each theater.

However, there are many problems in the conventional method as follows.

A first problem is that the conventional method costs a great deal to copy the film. And a second problem is that a large space is required to temporarily keep a large number of copied films.

Also, a third problem is that the content including images recorded on the films are degraded each time when the film or an original film is repeatedly copied, since the copied films are damaged and, as a result, cause numerous defects and noises to occur by repetition of copying in an analog method and reproducing operations.

### SUMMARY OF THE INVENTION

It is, therefore, an object of the invention to provide a reproducing system which reproduces a digital content of a movie. To reproduce movie images by using digital data, it is easy to deal with the digital data and a dual system should be prepared which includes two reproducing devices to increase reliability of reproducing process. And the digital data are also not degraded in the reproducing process.

Also, to solve the above problems, the invention provides a reproducing system to reproduce a digital content using reproducing technology of digital video and digital audio, which has recently improved greatly.

Further, it is an object of the invention to provide a delivery system to send/receive a digital content using a network such as the Internet.

According to a first aspect of the invention, there is provided a digital content reproducing system which comprises a content server which stores and manages a digital content of movies and a projecting or screening system which is connected to the content server via a network. Herein, the projecting system receives the digital content from the content server via the network and reproduces the digital content to show a movie.

According to a second aspect of the invention, there is provided a digital content reproducing system which comprises a content server which stores and manages a digital content of movies and a projecting system which is connected to the content server via a network. The projecting system receives the digital content from the content server via the network and reproduces the digital content to show a movie. Specifically, the projecting system comprises a reproducing device which supplies signals to reproduce the digital content and a backup reproducing device which supplies signals to reproduce the digital content when the reproducing device can not serve to reproduce the digital content. Furthermore, the backup reproducing device performs decoding process of the digital content while the reproducing device periodically sends a first predetermined signal to the backup reproducing device, and the backup reproducing device starts processing the decoded digital content and supplying the signals to reproduce the movie in addition to the decoding process when the reproducing device stops sending the first predetermined signal.

According to a third aspect of the invention, there is provided a digital content delivery system which comprises a first terminal which is located in a movie company, a second terminal which is located in a content deliver company, a third terminal which is located in an institution to show movies, and a network which connects the first terminal, the second terminal, and the third terminal to each other. Herein, movie information and a digital content of a movie are transmitted from the first terminal to the second terminal via the network. The movie information is transmitted from the second terminal to the third terminal via the network. In this situation, when the third terminal sends a request to the second terminal referring to the received movie information, the digital content are transmitted from the second terminal to the third terminal.

According to a fourth aspect of the invention, there is provided a method of reproducing a digital content. The method comprises the steps of, at a reproducing device, receiving a digital content of a movie, decoding the digital content, processing the decoded digital content and supplying signals to reproduce the movie, and periodically sending, in normal operation, a predetermined signal to a backup reproducing device. The method further comprises, at the backup reproducing device, the steps of receiving a digital content of a movie, decoding the digital content, receiving the predetermined signal from the reproducing device, and processing the decoded digital content and supplying signals to reproduce the movie, when the predetermined signal is not sent from the reproducing device.

According to a fifth aspect of the invention, there is provided a recording medium readable by a computer, tangibly embodying a program of instructions executable by the computers to perform a method of reproducing a digital content. The method includes the same steps as the method of the fourth aspect of the invention.

According to a sixth aspect of the invention, there is provided a computer data signal embodied in a carrier wave and representing a sequence of instructions which, when executed by a processor, cause the processor to perform a method of reproducing a digital content. The method includes the same steps as the method of the fourth aspect of the invention.

According to a seventh aspect of the invention, there is provided a program product comprising, computer readable instructions and a recording medium bearing the computer readable instructions; the instructions being adaptable to enable computers to perform a method of reproducing a digital content. The method includes the same steps as the method of the fourth aspect of the invention.

### BRIEF DESCRIPTION OF THE DRAWINGS

FIG. 1 shows a conventional process for reproducing images and a sound;

FIG. 2 shows a conventional process for delivering content of a movie;

FIG. 3 shows a network structure diagram of a digital content reproducing system according to a first embodiment of the invention;

FIG. 4 shows a block diagram representing a movie projecting system according to the first embodiment of the invention;

FIG. 5 shows a block diagram representing a reproducing device of the movie projecting system;

FIG. 6 shows a block diagram representing a backup reproducing device of the movie projecting system;

FIG. 7 shows a diagram for describing operations of the reproducing device, the backup reproducing device, and an AV input switching device;

FIG. 8 shows a network structure diagram of a digital content deliver system according to a second embodiment of the invention;

FIG. 9 shows a diagram for describing operations of the terminal of a movie company, a terminal of a content deliver company, and a terminal of a movie theater; and

FIG. 10 shows a block diagram representing another reproducing device according to a third embodiment of the invention.

### DESCRIPTION OF THE PREFERRED EMBODIMENT

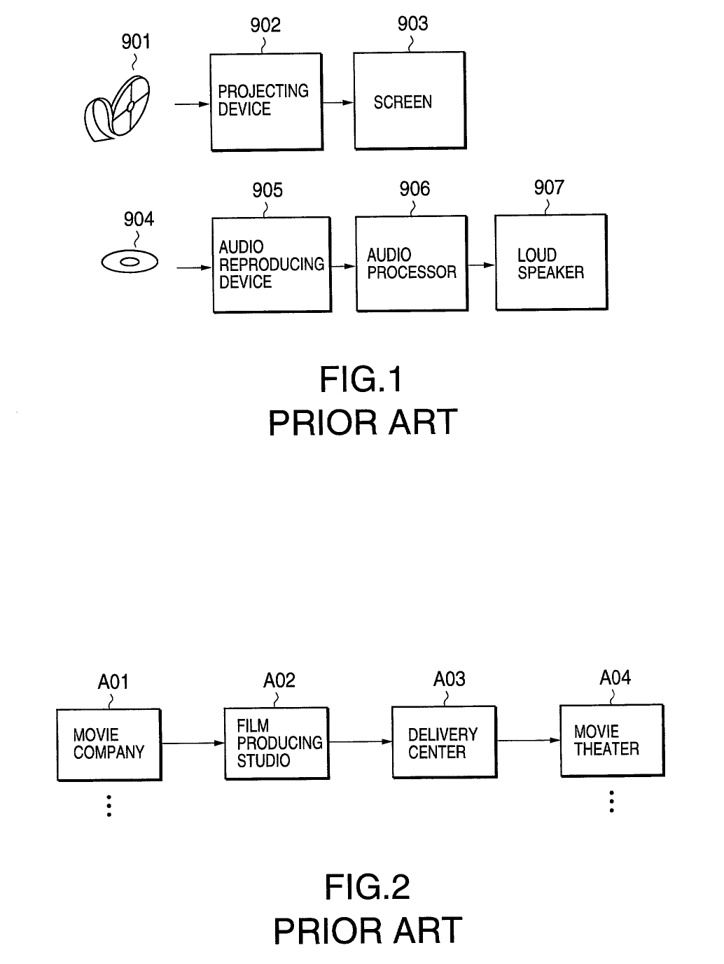

At first, description is made about a conventional reproducing process with reference to FIG. 1.

In FIG. 1, a film 901 recording images of a movie is mounted on a projecting device or projector 902 and the images are projected on a screen 903 by the projecting device 902.

A sound of the movie is provided from a recording medium such as a CD-ROM. As shown in FIG. 1, the CD-ROM 904 is firstly mounted on an audio reproducing device 905 and the device 905 reads out audio data from the CD-ROM 904. Then, an audio processor 906 receives the audio data from the audio reproducing device 905 and processes the audio data to send them to a loudspeaker 907. In such the process, a sound of the movie is supplied from the loudspeaker 907 in synchronism with the corresponding images.

Next, description is made about a conventional delivery process with reference to FIG. 2.

In FIG. 2, at first, a movie produced by a movie company A01 is recorded on a film at a film producing studio A02 and then, the movie is copied into a plurality of copied films, if necessary. Then, each of the films is delivered to a movie theater A04 where the film will be used or projected, via a delivery center A03.

The above-mentioned reproducing process and the delivery process have disadvantages as described in the preamble of the instant specification.

Next, description is made about a first embodiment of the invention in detail.

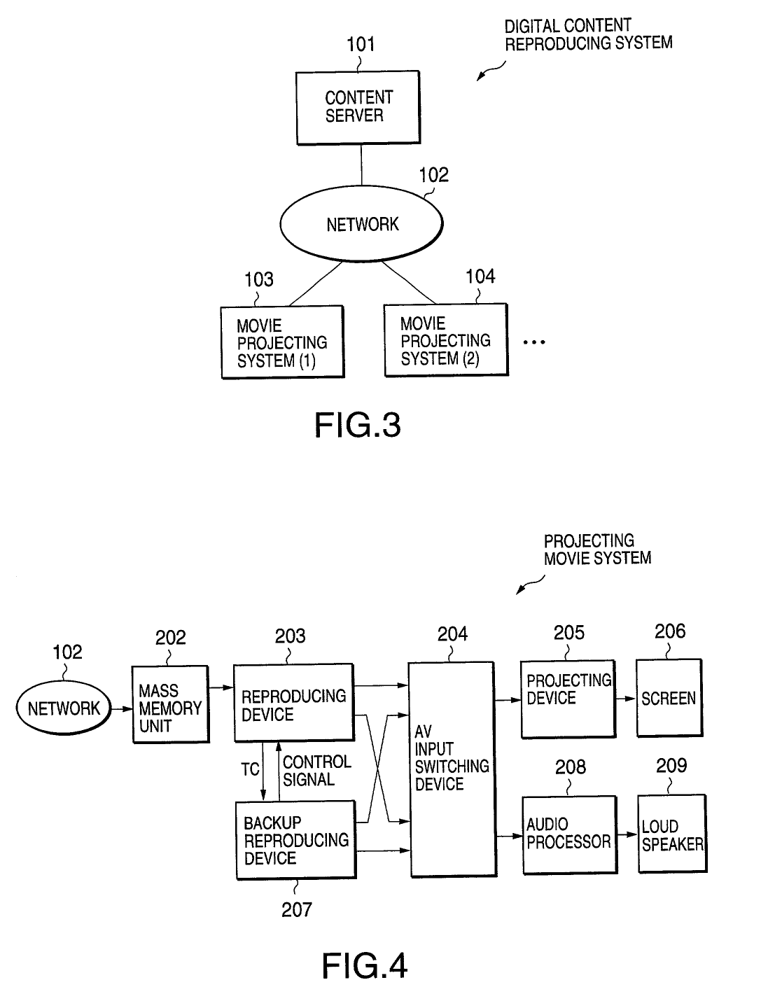

In FIG. 3, a digital content reproducing system according to the first embodiment of the invention includes a content server 101, a movie projecting system (1) 103, a movie projecting system (2) 104, and a network 102 such as a local area network which connects the above elements to each other.

The content server 101 is practically implemented by an information processing device such as a workstation server. The local area network 102 is a network which connects elements. Also, the movie projecting system (1) 103 and the movie projecting system (2) 104 are configured as a system shown in FIG. 4. In general, all of the illustrated elements, such as the content server 101, and the movie projecting systems 103 and 104 are located in the same movie theater. But, the elements may be located in different sites. In this case, the elements are connected through a network such as the Internet or WAN.

Referring to FIG. 4, the projecting system includes a mass memory unit 202 which is connected to the local area network 102 shown in FIG. 3 and can store a large volume of a content, a reproducing device 203 for reproducing a content, and a backup reproducing device 207 which alternatively reproduces the content when the reproducing device 203 is inactive for some reason.

The movie projecting system further includes an AV input switching device 204 which selectively outputs data from the reproducing device 203 or data from the backup reproducing device 207. The device 204 receives both the output data from the reproducing device 203 and the output data from the backup reproducing device 207. And the device 204 automatically determines which device outputs effective data, and outputs signals from the determined device. TC (time code) and a control signal are transmitted between the reproducing device 203 and the backup reproducing device 207.

The movie projecting system still further includes a projecting device or projecting device 205 which projects images on a screen 206 by using the received signals, and an audio processor 208 which supplies effective sound data to a loudspeaker 209 by using the received signals.

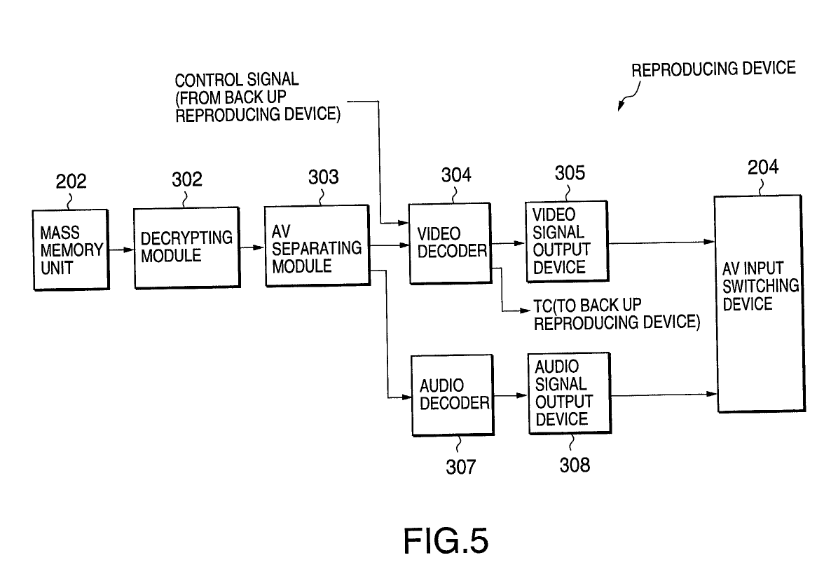

Next, description is made about the reproducing device 203 with reference to FIG. 5.

The device 203 includes a decrypting module 302, an AV separating module 303, a video decoder 304, a video signal output device 305, an audio decoder 307, and an audio signal output device 308.

The mass memory unit 202 and the AV input switching device 204 shown in FIG. 5 are the same elements as identical with those shown in FIG. 4.

Herein, the decrypting module 302 is connected to the mass memory unit 202 and decrypts encrypted content supplied from the mass memory unit 202.

Also, the AV separating module 303 separates the decrypted content into video data and audio data, and the video decoder 304 decodes the video data subjected to digital compression. In addition, the video signal output device 305 receives the decoded video data and outputs video signals to the AV input switching device 204. On the other hand, the audio decoder 307 decodes the compressed audio data and the audio signal output device 308 receives the decoded audio data and outputs audio signals to the AV input switching device 204.

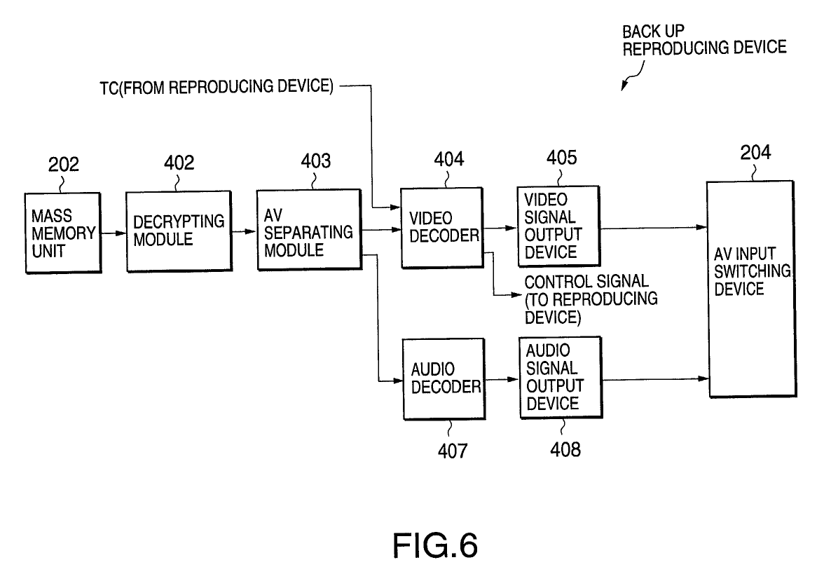

Although configuration of the backup reproducing device 207 is shown in FIG. 6, description about each element is omitted because the configuration is similar to the above described configuration of the reproducing device 203 in connection with FIG. 5.

The mass memory unit 202 is implemented by a memory unit, such as a hard disk, which can easily rewrite its content. The decrypting modules 302 and 402, the AV separating modules 303 and 403, the video decoders 304 and 404, the video signal output devices 305 and 405, the audio decoders 307 and 407, and the audio signal output devices 308 and 408 may be installed in an information processing device such as a personal computer, or may be embedded in a dedicated device.

Also, the video decoder 304 of the reproducing device 203 communicates a TC (time code) and a control signal with the video decoder 404 of the backup reproducing device 207. Specifically, the video decoder 304 sends the TC to the video decoder 404, and the video decoder 404 sends the control signal to the video decoder 304.

Next, description is made about operations of the reproducing system according to the first embodiment of the invention with reference to FIGS. 3-6.

Referring FIG. 3, the projecting system (1) 103 and the projecting system (2) 104 are located in a movie theater. A movie content is stored and managed in the content server 101 and are downloaded to the systems 103 and 104 via the local area network in the movie theater.

The downloaded data (a movie content) are stored in the mass memory unit 202 shown in FIG. 4. The data may be downloaded only once for a theater, and may not thereafter be downloaded while the movie is reproduced or screened at the movie theater.

In reproducing the movie content, as described above in connection with FIGS. 5 and 6, the downloaded data (a movie content) are read and processed by the reproducing device 203 or the backup reproducing device 207 and, as a result, sent to the AV input switching device 204 in the forms of video signals and audio signals.

The AV input switching device 204 selects and outputs the input signals from the system 203 or 207. Generally, since only the reproducing device 203 supplies the signals, the device 204 selects the signals from the device 203.

If the reproducing device 203 stops reproducing process for some reason, the backup reproducing device 207 automatically reproduces the data instead of the device 203 and the AV input switching device 204 automatically selects the signals from the backup reproducing device 207.

Video signals supplied from the AV input switching device 204 are projected to the screen 206 by the projecting device 205 such as a projector. On the other hand, necessary effective process is performed on the audio signals and then the audio signals are supplied to the loudspeaker 209. Herein, although the loudspeaker 209 is represented as a single loudspeaker, a plurality of loudspeakers may be used according to a projecting system employed in a movie theater.

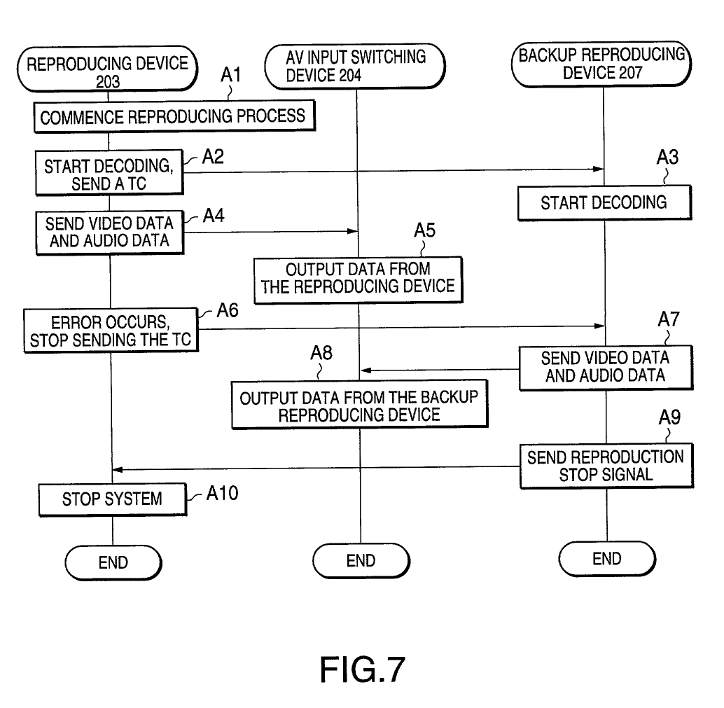

Next, description is made with reference to FIG. 7 about operations to switch input a content at the AV input switching device 204.

In step A1, a reproducing process is started or commenced by the reproducing device 203. Simultaneously with decoding process, a TC (time code) is sent to the backup reproducing device 207 (step A2).

When the backup reproducing device 207 receives the TC, the device 207 starts decoding process (step A3). The reproducing device 203 sends the decoded data (video data and audio data) to the AV input switching device 204 (step A4). When the AV input switching device 204 receives the decoded data, the device 204 outputs the data to the corresponding device, that is, the projecting device 205 or the audio processor 208 (step A5).

Herein, if an error (or system trouble) occurs at the reproducing device 203, the transmission of the TC to the backup reproducing device 207 is stopped (step A6). When the backup reproducing device 207 determines that the transmission of the TC is stopped, the device 207 starts outputting the video data and the audio data to be supplied after the reproducing device 203 stops the transmission (step A7).

When the AV input switching device 204 determines that the transmission of the signals from the reproducing device 203 is stopped and the transmission of the signals from the backup reproducing device 207 is started, the device 204 is switched to input the signals from the backup reproducing device 207 (step A8).

Immediately after the switching at the AV input switching device 204, the backup reproducing device 207 sends a reproduction stop signal to the reproducing system 203 (step A9). When the reproducing device 203 receives the reproduction stop signal, the device 203 finishes the process executed in the device (step A10).

As described above, if the reproducing device 203 stops its reproducing process due to some reason, the backup reproducing device 207 immediately starts the reproducing process instead of the reproducing device 203 and then supplies the decoded video data and the decoded audio data.

Therefore, images supplied on the screen and a sound supplied via the loudspeaker are successively provided even if one of the reproducing devices (203 or 207) is stopped.

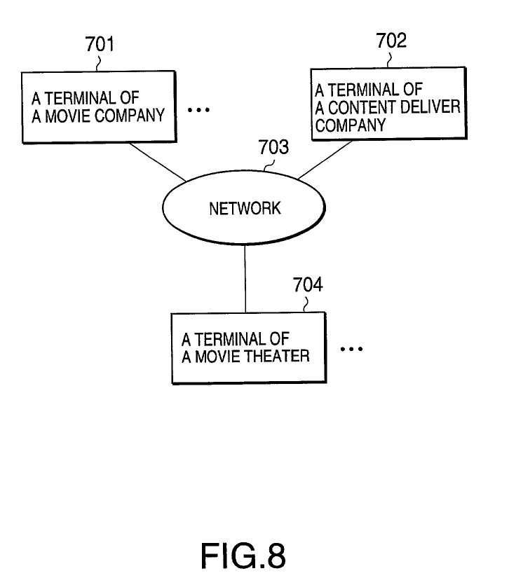

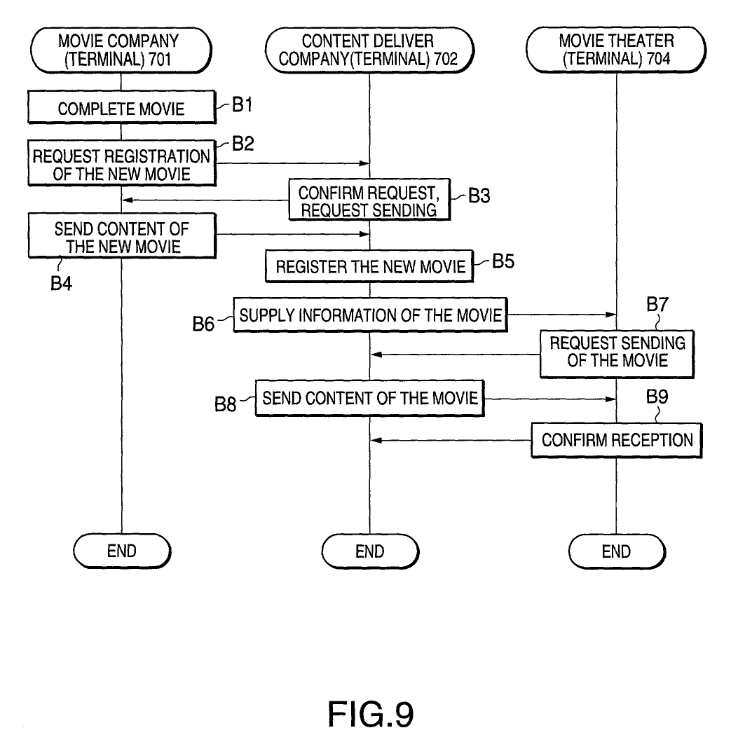

Next, description is made about operations to deliver a digital content according to a second embodiment of the invention with reference to FIGS. 8 and 9.

Referring to FIG. 8, a plurality of movie companies produce movies and each of a plurality of movie theaters shows the movies in a predetermined duration. And one or more content deliver companies deliver contents of the movies to each movie theater for projecting.

Terminals 701 located in the movie companies, terminals 704 located in the movie theaters, and terminals 702 located in the content deliver companies are connected to each other via a network 703 such as the Internet, WAN, or MAN.

Then, in FIG. 9, at first, when a new movie is completed by one of the movie companies (step B1), the movie company asks one of the content deliver companies to register the new movie (step B2). When the content deliver company confirms the request by the terminal 702, the company sends a sending request to the movie company using the terminal 702 (step B3).

When the movie company receives the sending request from the content deliver company, the movie company sends the content of the new movie and other information to the content deliver company by using the terminal 701 (step B4). The content deliver company registers the received content of the new movie and the other information (step B5), and sends the information to the terminals 704 of the movie theaters (step B6).

Each movie theater requests the content delivery company to send the content based on the received information by using the terminal 704 (step B7). The content deliver company sends the requested content to the movie theater which requests the content (step B8). The movie theater receives the content from the content deliver company and if the reception is completed with no problem, the movie theater sends a confirmation message to the content deliver company (step B9).

The above transaction of content is performed on an assumption that a contract has been concluded in advance among the companies and movie theater. Also, in general, the delivered content is encrypted by using a cipher which is known by the companies and the movie theater.

The request or confirmation message may be sent by using a conventional electrical mail system.

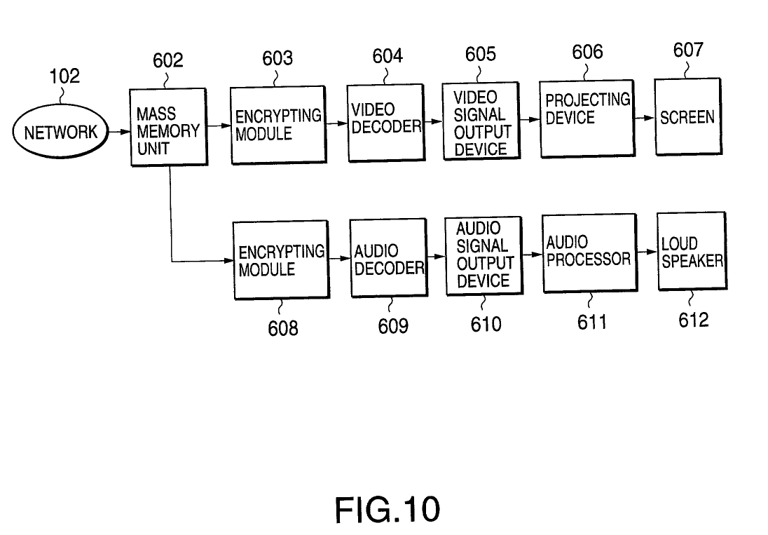

Next, description is made about configuration of a reproducing device according to a third embodiment of the invention with reference to FIG. 10.

The reproducing device shown in FIG. 10 is different from the devices shown in FIGS. 5 and 6 in that digital content has been already separated into video data and audio data when the digital content is supplied to the device.

The data format of the digital content is, for example, DTS (Digital Theater System), which has been spread recently and can give the feeling of being at a live performance.

Data entered from a local area network 102 are stored in a mass memory unit 602. Herein, the data has been already separated into video data and audio data, and the video data and the audio data are individually stored in different areas in the mass memory unit 602.

The video data are encoded by a video decoder 604 after the video data are encrypted by an encrypting module 603. The encoded video data are then projected on a screen 607 by a projecting device 606 through a video signal output device 605.

On the other hand, the audio data are encoded by a audio decoder 609 after the audio data are encrypted by an encrypting module 608. The encoded audio data are then sent to a loudspeaker 612 by an audio processor 611 through an audio signal output device 610.

Herein, description about a backup reproducing device is omitted, but the reproducing device according to the third embodiment of the invention also is applied to the backup reproducing device.

Also, the video signal output device 605 and the audio signal output device 610 of the reproducing device shown in FIG. 10 can output the corresponding signals to the AV input switching device 204 in the same way as shown in FIGS. 5 and 6.

The reproducing device of the invention can produce images and sound with high quality (high image quality and high audio quality) as compared with reproduction of a film (that is, reproduction of an analog content). This is because digital video data and digital audio data are used and reproduced in the invention. Also, there are outstanding effectiveness, that is, a space to keep the digital data is reduced and degradation of image quality and audio quality is prevented.

Further, since the backup reproducing device is provided in addition to the reproducing device, if the reproducing system is in trouble, reproducing process is continuously performed by immediately starting the backup reproducing device when the reproducing device is in trouble.

Furthermore, since the content data of a movie are delivered via a network such as the Internet, conventional cost and time for delivering and copying can be reduced.

What is claimed is:

1. A digital content reproducing system comprising:
a content server which stores and manages a digital content of movies; and
a projecting system which is connected to the content server via a network, receives the digital content from the content server via the network, and reproduces the digital content to show a movie.

2. The digital content reproducing system of claim 1, wherein the projecting system comprises:
a mass memory unit which stores the digital content supplied via the network;
a reproducing device which produces signals to reproduce the digital content;
a backup reproducing device which reproduces the digital content when the reproducing device can not serve to reproduce the digital content; and
an AV input switching device which receives output signals from the reproducing device and the backup reproducing device and selects output signals from an active one of the reproducing device and the backup reproducing device to produce the selected output signals.

3. The digital content reproducing system of claim 2, wherein the output signals supplied from the reproducing device and the backup reproducing device are each separated into video signals and audio signals, and wherein the projecting system further comprises:
a projecting device which receives the video signals from the AV switching device and projects them on a screen; and
an audio processor which receives the audio signals from the AV switching device and outputs them to a loudspeaker.

4. The digital content reproducing system of claim 3, wherein the reproducing device and the backup reproducing device comprise the same elements and each of the devices comprises:
an encrypting module which is connected to the mass memory unit and encrypts the digital content received from the mass memory unit;
an AV separating module which receives the digital content from the encrypting module and separates them into the video signals and the audio signals;
a video decoder which receives the video signals from the AV separating module and decodes them;
a video signal output device which receives the decoded video signals from the video decoder and outputs them to the AV input switching device;
an audio decoder which receives the audio signals from the AV separating module and decodes them; and
an audio signal output device which receives the decoded audio signals from the audio decoder and outputs them to the AV input switching device.

5. The digital content reproducing system of claim 4, wherein the backup reproducing device decodes the signals at the video decoder and the audio decoder while the reproducing device periodically sends a first predetermined signal to the backup reproducing device, and wherein the backup reproducing device starts sending process of the decoded signals to the AV input switching device in addition to the decoding process when the reproducing device stops sending the first predetermined signal.

6. The digital content reproducing system of claim 5, wherein the backup reproducing device sends a second predetermined signal to instruct the reproducing device to stop, after the backup reproducing device starts the sending process.

7. The digital content reproducing system of claim 3, wherein the digital content is individually supplied in the form of video data and audio data, and wherein the reproducing device and the backup reproducing device comprise the same elements and each of the devices comprises a video data processing section and an audio processing section, the video data processing section comprising:
a first encrypting module which is connected to the mass memory unit and encrypts the video data received from the mass memory unit;
a video decoder which receives the video signals from the first encrypting module and decodes them;
a video signal output device which receives the decoded video signals from the video decoder and outputs them to the AV input switching device, the audio data processing section comprising:
a second encrypting module which is connected to the mass memory unit and encrypts the audio data received from the mass memory unit;
an audio decoder which receives the audio signals from the second encrypting module and decodes them; and
an audio signal output device which receives the decoded audio signals from the audio decoder and outputs them to the AV input switching device.

8. The digital content reproducing system of claim 7, wherein the video signal output device supplies the decoded video signals to the projecting device not through the AV input switching device and/or the audio signal output device supplies the decoded audio signals to the audio processor not through the AV input switching device.

9. The digital content reproducing system of claim 7, wherein the backup reproducing device decodes the signals at the video decoder and the audio decoder while the reproducing device periodically sends a first predetermined signal to the backup reproducing device, and wherein the backup reproducing device starts sending process of the decoded signals to the AV input switching device in addition to the decoding process when the reproducing device stops sending the first predetermined signal.

10. The digital content reproducing system of claim 9, wherein the backup reproducing device sends a second predetermined signal to instruct the reproducing device to stop, after the backup reproducing device starts the sending process.

11. The digital content reproducing system of claim 1, wherein the content server, the projecting system, and the network are located in an institution to show movies.

12. A digital content reproducing system comprising:
a content server which stores and manages a digital content of movies; and
a projecting system which is connected to the content server via a network, wherein the projecting system receives the digital content from the content server via the network and reproduces the digital content to show a movie, the projecting system comprises a reproducing device which supplies signals to reproduce the digital content and a backup reproducing device which supplies signals to reproduce the digital content when the reproducing device can not serve to reproduce the digital content, and wherein the backup reproducing device performs decoding process of the digital content while the reproducing device periodically sends a first predetermined signal to the backup reproducing device, and the backup reproducing device starts processing the decoded digital content and supplying the signals to reproduce the movie in addition to the decoding process when the reproducing device stops sending the first predetermined signal.

13. A digital content delivery system comprising:
a first terminal which is located in a movie company;
a second terminal which is located in a content deliver company;
a third terminal which is located in an institution to show movies; and
a network which connects the first terminal, the second terminal, and the third terminal to each other,
wherein movie information and a digital content of a movie are transmitted from the first terminal to the second terminal via the network, the movie information are transmitted from the second terminal to the third terminal via the network, and when the third terminal sends a request to the second terminal referring to the received movie information, the digital content is transmitted from the second terminal to the third terminal.

14. A method of reproducing a digital content at either one of a reproducing device and a backup reproducing device, comprising, at the reproducing device, the steps of:
receiving a digital content of a movie;
decoding the digital content;
processing the decoded digital content and supplying signals to reproduce the movie; and
periodically sending, in normal operation, a predetermined signal to a backup reproducing device;
at the backup reproducing device, the steps of:
receiving a digital content of a movie;
decoding the digital content;
receiving the predetermined signal from the reproducing device; and
processing the decoded digital content and supplying signals to reproduce the movie, when the predetermined signal is not sent from the reproducing device.

15. A recording medium readable by a computer, tangibly embodying a program of instructions executable by the computers to perform a method of reproducing a digital content comprising the steps of:
at a reproducing device, receiving a digital content of a movie;
decoding the digital content;
processing the decoded digital content and supplying signals to reproduce the movie; and
periodically sending, in normal operation, a predetermined signal to a backup reproducing device;
at the backup reproducing device, receiving a digital content of a movie;
decoding the digital content;
receiving the predetermined signal from the reproducing device; and
processing the decoded digital content and supplying signals to reproduce the movie, when the predetermined signal is not sent from the reproducing device.

16. A computer data signal embodied in a carrier wave and representing a sequence of instructions which, when executed by a processor, cause the processor to perform a method of reproducing a digital content comprising the steps of:
at a reproducing device, receiving a digital content of a movie;
decoding the digital content;
processing the decoded digital content and supplying signals to reproduce the movie; and
periodically sending, in normal operation, a predetermined signal to a backup reproducing device;
at the backup reproducing device, receiving a digital content of a movie;
decoding the digital content;
receiving the predetermined signal from the reproducing device; and
processing the decoded digital content and supplying signals to reproduce the movie, when the predetermined signal is not sent from the reproducing device.

17. A program product comprising, computer readable instructions and a recording medium bearing the computer readable instructions; the instructions being adaptable to enable computers to perform a method of reproducing a digital content comprising the steps of:
at a reproducing device, receiving a digital content of a movie;
decoding the digital content;
processing the decoded digital content and supplying signals to reproduce the movie; and
periodically sending, in normal operation, a predetermined signal to a backup reproducing device;
at the backup reproducing device, receiving a digital content of a movie;
decoding the digital content;
receiving the predetermined signal from the reproducing device; and
processing the decoded digital content and supplying signals to reproduce the movie, when the predetermined signal is not sent from the reproducing device.
